(19) United States
(12) Patent Application Publication
(10) Pub. No.: US 2015/0030349 A1
(43) Pub. Date: Jan. 29, 2015

(54) CLEANING DEVICE AND IMAGE FORMING APPARATUS

(71) Applicant: KONICA MINOLTA, INC., Tokyo (JP)

(72) Inventor: Satoru OSAWA, Tokyo (JP)

(21) Appl. No.: 14/337,381

(22) Filed: Jul. 22, 2014

(30) Foreign Application Priority Data
Jul. 24, 2013 (JP) 2013-153532

(51) Int. Cl. G03G 15/16

(52) U.S. Cl. CPC G03G 15/161
USPC 399/101

(57) ABSTRACT

A cleaning device includes a first cleaning section and a second cleaning section. The first cleaning section applies, to a first collecting roller, a voltage for electrostatically attaching toner oppositely charged at a first foamed roller to the first collecting roller from the first foamed roller. The second cleaning section applies, to a second collecting roller, a voltage for electrostatically attaching toner oppositely charged at a second foamed roller to the second collecting roller from the second foamed roller.

### CROSS REFERENCE TO RELATED APPLICATIONS

This application is entitled and claims the benefit of Japanese Patent Application No. 2013-153532, filed on Jul. 24, 2013, the disclosure of which including the specification, drawings and abstract is incorporated herein by reference in its entirety.

### BACKGROUND OF THE INVENTION

1. Field of the Invention

The present invention relates to a cleaning device and an image forming apparatus.

2. Description of Related Art

In general, an electrophotographic image forming apparatus (such as a printer, a copy machine, and a fax machine) is configured to irradiate (expose) a charged photoconductor with (to) laser light based on image data to form an electrostatic latent image on the surface of the photoconductor. The electrostatic latent image is then visualized by supplying toner from a developing device to the photoconductor (image carrier) on which the electrostatic latent image is formed, whereby a toner image is formed. Further, the toner image is directly or indirectly transferred to a sheet, followed by heating and pressurization, whereby an image is formed on the sheet.

For example, in an image forming apparatus of an intermediate transfer belt type, a toner image formed on a photoconductor is transferred to an intermediate transfer belt, and the toner image transferred to the intermediate transfer belt is transferred to a sheet. In this process, the toner is not completely transferred to the sheet and remains on the surface of the intermediate transfer belt. The remaining toner hinders subsequent image forming, and causes a problem that a favorable transfer image cannot be obtained. Therefore, the image forming apparatus is provided with a cleaning device that removes the remaining toner.

The cleaning device is provided with a cleaning roller that removes the toner on the surface of the intermediate transfer belt. In particular, in image forming apparatuses for use in light-duty printing such as production printing, a large amount of toner is frequently transferred to the intermediate transfer belt. Therefore, it is desirable that, in image forming apparatuses for production printing, the cleaning roller have a function for instantly removing a large amount of toner. In order to ensure such a removing function, a brush roller has been used as the cleaning roller (see, for example, Japanese Patent Application Laid-Open Nos. 2012-42594, 2013-45003, 2012-185288, 2012-83640, and 2012-88557).

However, when a brush roller is used as a cleaning roller, electrostatic discharge is caused between the brush roller and toner when the brush roller removes the toner remaining on the intermediate transfer belt, thus causing a filming phenomenon of the toner on the intermediate transfer belt (a phenomenon in which an additive or the like of the toner in a thin film form attaches to the intermediate transfer belt). When the filming phenomenon is caused, decrease in smoothness of the intermediate transfer belt and increase in resistance of intermediate transfer belt are caused, and thereafter, an image defect such as a density difference in a formed image is caused.

On the other hand, when a foamed roller, in which the contact area with an intermediate transfer belt is large, or in other words, the number of electric discharge points is small, is used as a cleaning roller, the filming phenomenon of the toner on the intermediate transfer belt can be limited at the time when the foamed roller removes the toner remaining on the intermediate transfer belt.

However, in comparison with the case of brush rollers, the toner taken by a foamed roller tends to be oppositely charged under the influence of the bias voltage applied to the foamed roller. Thus, the toner which is once removed by the foamed roller and is then oppositely charged tends to be again attached to the surface of the intermediate transfer belt from the foamed roller side, and a favorable cleaning for the intermediate transfer belt cannot be achieved.

It is to be noted that the techniques disclosed in Japanese Patent Application Laid-Open Nos. 2012-42594, 2013-45003, 2012-185288, 2012-83640, and 2012-88557 are based on the use of the brush roller as the cleaning roller, and are not directed to prevent the toner once removed by the foamed roller from being again attached to the surface of the intermediate transfer belt, and therefore, configurations for such a purpose are not found in the techniques.

### SUMMARY OF THE INVENTION

An object of the present invention is to provide a cleaning device and an image forming apparatus which can prevent toner removed by a foamed roller from being again attached to the surface of a transfer belt in the case where the foamed roller is used as a cleaning roller, and thus can achieve favorable cleaning for the transfer belt.

To achieve the abovementioned object a cleaning device reflecting one aspect of the present invention includes a first cleaning section and a second cleaning section, the first cleaning section including: a first foamed roller disposed in such a manner that the first foamed roller is rotatable while making contact with a transfer belt, the first foamed roller being configured to remove toner of a first polarity remaining on the transfer belt; a first collecting roller disposed in such a manner that the first collecting roller is rotatable while making contact with the first foamed roller, the first collecting roller being configured to collect toner attached to the first foamed roller; and a first voltage applying section configured to apply, to the first foamed roller, a voltage for electrostatically attaching the toner of the first polarity existing on the transfer belt to the first foamed roller and for oppositely charging the toner, and to apply, to the first collecting roller, a voltage for electrostatically attaching the toner oppositely charged at the first foamed roller to the first collecting roller from the first foamed roller; the second cleaning section including: a second foamed roller disposed, on a downstream side of the first foamed roller in a travelling direction of the transfer belt, in such a manner that the second foamed roller is rotatable while making contact with the transfer belt, the second foamed roller being configured to remove toner of a second polarity remaining on the transfer belt, the second polarity being opposite to the first polarity; a second collecting roller disposed in such a manner that the second collecting roller is rotatable while making contact with the second foamed roller, the second collecting roller being configured to collect toner attached to the second foamed roller; and a second voltage applying section configured to apply, to the second foamed roller, a voltage for electrostatically attaching the toner of the second polarity existing on the transfer belt to the second foamed roller and for oppositely charging the toner, and to apply, to the second collecting roller, a voltage for electrostatically attaching the toner oppositely charged at the second foamed roller to the second collecting roller from the second foamed roller.

Desirably, in the cleaning device, the first voltage applying section applies, to the first collecting roller, a voltage which has a same polarity as a polarity of a voltage applied to the first foamed roller and is lower in absolute value than the voltage applied to the first foamed roller, and the second voltage applying section applies, to the second collecting roller, a voltage which has a same polarity as a polarity of a voltage applied to the second foamed roller and is lower in absolute value than the voltage applied to the second foamed roller.

Desirably, in the cleaning device, the first voltage applying section applies, to the first collecting roller, a voltage which has a polarity opposite to a polarity of a voltage applied to the first foamed roller, and the second voltage applying section applies, to the second collecting roller, a voltage which has a polarity opposite to a polarity of a voltage applied to the second foamed roller.

Desirably, the cleaning device further includes a third cleaning section, the third cleaning section including: a third foamed roller disposed on an upstream side of the first foamed roller or on a downstream side of the second foamed roller in the travelling direction of the transfer belt in such a manner that the third foamed roller is rotatable while making contact with the transfer belt, the third foamed roller being configured to remove toner remaining on the transfer belt; a third collecting roller disposed in such a manner that the third collecting roller is rotatable while making contact with the third foamed roller, the third collecting roller being configured to collect toner attached to the third foamed roller; and a third voltage applying section configured to apply, to the third foamed roller, a voltage for electrostatically attaching the toner existing on the transfer belt to the third foamed roller and for oppositely charging the toner, and to apply, to the third collecting roller, a voltage for electrostatically attaching the toner oppositely charged at the third foamed roller to the third collecting roller from the third foamed roller.

Desirably, the cleaning device further includes a hard roller disposed on an upstream side of the first the cleaning section in the travelling direction of the transfer belt in such a manner that the hard roller is rotatable while making contact with the transfer belt, the hard roller being configured to remove toner remaining on the transfer belt.

Desirably, the cleaning device further includes a hard roller disposed, on a downstream side of the second cleaning section in the travelling direction of the transfer belt, in such a manner that the hard roller is rotatable while making contact with the transfer belt, the hard roller being configured to remove toner remaining on the transfer belt.

An image forming apparatus reflecting one aspect of the present invention includes a first cleaning section and a second cleaning section, the first cleaning section including: a first foamed roller disposed in such a manner that the first foamed roller is rotatable while making contact with a transfer belt, the first foamed roller being configured to remove toner of a first polarity remaining on the transfer belt; a first collecting roller disposed in such a manner that the first collecting roller is rotatable while making contact with the first foamed roller, the first collecting roller being configured to collect toner attached to the first foamed roller; and a first voltage applying section configured to apply, to the first foamed roller, a voltage for electrostatically attaching the toner of the first polarity existing on the transfer belt to the first foamed roller and for oppositely charging the toner, and to apply, to the first collecting roller, a voltage for electrostatically attaching the toner oppositely charged at the first foamed roller to the first collecting roller from the first foamed roller, the second cleaning section including: a second foamed roller disposed on a downstream side of the first foamed roller in a travelling direction of the transfer belt in such a manner that the second foamed roller is rotatable while making contact with the transfer belt, the second foamed roller being configured to remove toner of a second polarity remaining on the transfer belt, the second polarity being opposite to the first polarity; a second collecting roller disposed in such a manner that the second collecting roller is rotatable while making contact with the second foamed roller, the second collecting roller being configured to collect toner attached to the second foamed roller; and a second voltage applying section configured to apply, to the second foamed roller, a voltage for electrostatically attaching the toner of the second polarity existing on the transfer belt to the second foamed roller and for oppositely charging the toner, and to apply, to the second collecting roller, a voltage for electrostatically attaching the toner oppositely charged at the second foamed roller to the second collecting roller from the second foamed roller.

Desirably, in the image forming apparatus, the first voltage applying section applies, to the first collecting roller, a voltage which has a same polarity as a polarity of a voltage applied to the first foamed roller and is lower in absolute value than the voltage applied to the first foamed roller, and the second voltage applying section applies, to the second collecting roller, a voltage which has a same polarity as a polarity of a voltage applied to the second foamed roller and is lower in absolute value than the voltage applied to the second foamed roller.

Desirably, in the image forming apparatus, the first voltage applying section applies, to the first collecting roller, a voltage which has a polarity opposite to a polarity of a voltage applied to the first foamed roller, and the second voltage applying section applies, to the second collecting roller, a voltage which has a polarity opposite to a polarity of a voltage applied to the second foamed roller.

Desirably, the image forming apparatus further includes a third cleaning section, the third cleaning section including: a third foamed roller disposed on an upstream side of the first foamed roller or on a downstream side of the second foamed roller in the travelling direction of the transfer belt in such a manner that the third foamed roller is rotatable while making contact with the transfer belt, the third foamed roller being configured to remove toner remaining on the transfer belt, a third collecting roller disposed in such a manner that the third collecting roller is rotatable while making contact with the third foamed roller, the third collecting roller being configured to collect toner attached to the third foamed roller, and a third voltage applying section configured to apply, to the third foamed roller, a voltage for electrostatically attaching the toner existing on the transfer belt to the third foamed roller and for oppositely charging the toner, and to apply, to the third collecting roller, a voltage for electrostatically attaching the toner oppositely charged at the third foamed roller to the third collecting roller from the third foamed roller.

Desirably, the image forming apparatus further includes a hard roller disposed on an upstream side of the first the cleaning section in the travelling direction of the transfer belt in such a manner that the hard roller is rotatable while making contact with the transfer belt, the hard roller being configured to remove toner remaining on the transfer belt.

Desirably, the image forming apparatus further includes a hard roller disposed on a downstream side of the second cleaning section in the travelling direction of the transfer belt in such a manner that the hard roller is rotatable while making contact with the transfer belt, the hard roller being configured to remove toner remaining on the transfer belt.

### BRIEF DESCRIPTION OF DRAWINGS

The present invention will become more fully understood from the detailed description given hereinbelow and the appended drawings which are given by way of illustration only, and thus are not intended as a definition of the limits of the present invention, and wherein:

FIG. 1 schematically illustrates a general configuration of an image forming apparatus according to an embodiment of the present invention;

FIG. 2 illustrates a principal part of a control system of the image forming apparatus according to the present embodiment;

FIG. 3 illustrates a configuration of a main part of a belt cleaning device according to the present embodiment;

FIG. 4 illustrates a modification of the configuration of the main part of the belt cleaning device according to the present embodiment;

FIG. 5 illustrates a modification of the configuration of the main part of the belt cleaning device according to the present embodiment; and

FIG. 6 illustrates a modification of the configuration of the main part of the belt cleaning device according to the present embodiment.

### DESCRIPTION OF THE PREFERRED EMBODIMENTS

In the following, the present embodiment is described in detail with reference to the drawings.

### [Configuration of Image Forming Apparatus 1]

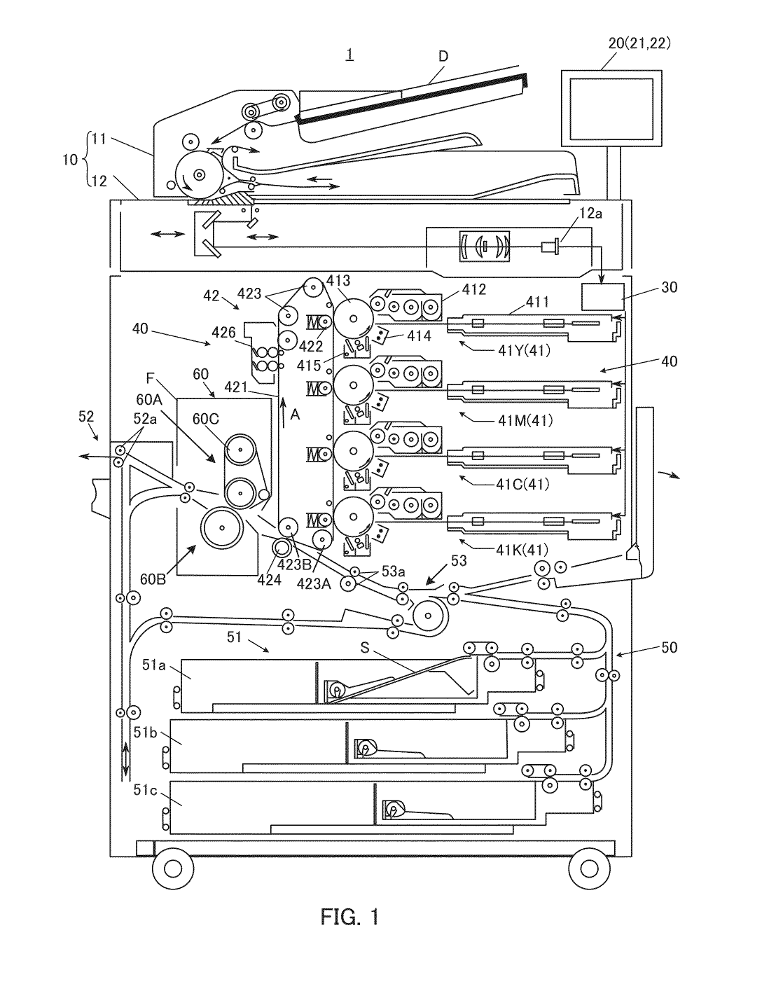

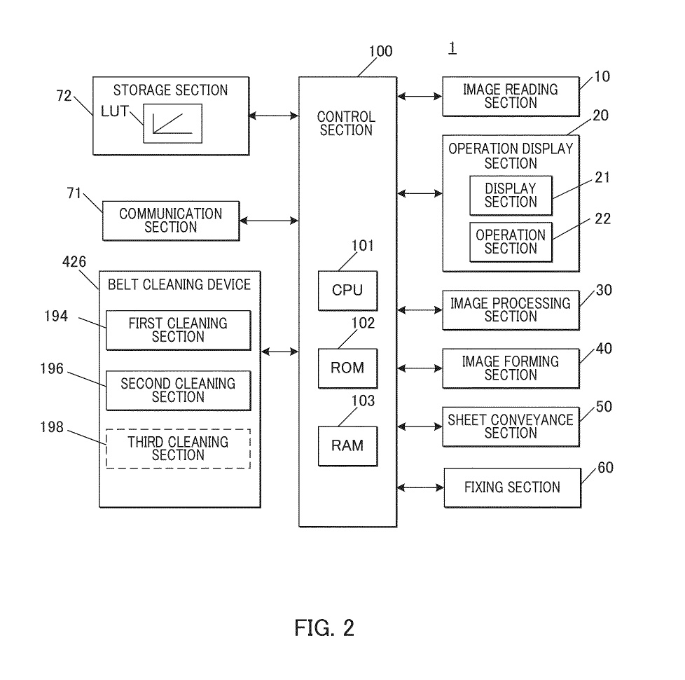

FIG. 1 illustrates an overall configuration of image forming apparatus 1 according to the embodiment of the present invention. FIG. 2 illustrates a principal part of a control system of image forming apparatus 1 according to the embodiment. Image forming apparatus 1 illustrated in FIGS. 1 and 2 is a color image forming apparatus with an intermediate transfer system using electrophotographic process technology. That is, image forming apparatus 1 transfers (primary-transfers) toner images of yellow (Y), magenta (M), cyan (C), and black (K) formed on photoconductor drums 413 to intermediate transfer belt 421, and superimposes the toner images of the four colors on one another on intermediate transfer belt 421. Then, image forming apparatus 1 transfers (secondary-transfers) the resultant image to sheet S, to thereby form an image.

A longitudinal tandem system is adopted for image forming apparatus 1. In the longitudinal tandem system, respective photoconductor drums 413 corresponding to the four colors of YMCK are placed in series in the travelling direction (vertical direction) of intermediate transfer belt 421, and the toner images of the four colors are sequentially transferred to intermediate transfer belt 421 in one cycle.

As illustrated in FIG. 2, image forming apparatus 1 includes image reading section 10, operation display section 20, image processing section 30, image forming section 40, sheet conveyance section 50, fixing section 60, and control section 100.

Control section 100 includes central processing unit (CPU) 101, read only memory (ROM) 102, random access memory (RAM) 103 and the like. CPU 101 reads a program suited to processing contents out of ROM 102, develops the program in RAM 103, and integrally controls an operation of each block of image forming apparatus 1 in cooperation with the developed program. At this time, CPU 101 refers to various kinds of data stored in storage section 72. Storage section 72 is composed of, for example, a non-volatile semiconductor memory (so-called flash memory) or a hard disk drive.

Control section 100 transmits and receives various data to and from an external apparatus (for example, a personal computer) connected to a communication network such as a local area network (LAN) or a wide area network (WAN), through communication section 71. Control section 100 receives, for example, image data transmitted from the external apparatus, and performs control to form an image on sheet S on the basis of the image data (input image data). Communication section 71 is composed of, for example, a communication control card such as a LAN card.

Image reading section 10 includes auto document feeder (ADF) 11, document image scanner (scanner) 12, and the like.

Auto document feeder 11 causes a conveyance mechanism to feed document D placed on a document tray, and sends out document D to document image scanner 12. Auto document feeder 11 enables images (even both sides thereof) of a large number of documents D placed on the document tray to be successively read at once.

Document image scanner 12 optically scans a document fed from auto document feeder 11 to its contact glass or a document placed on its contact glass, and images light reflected from the document on the light receiving surface of charge coupled device (CCD) sensor 12a, to thereby read the document image. Image reading section 10 generates input image data on the basis of a reading result provided by document image scanner 12. Image processing section 30 performs predetermined image processing on the input image data.

Operation display section 20 includes, for example, a liquid crystal display (LCD) with a touch panel, and functions as display section 21 and operation section 22. Display section 21 displays various operation screens, image statuses, the operating conditions of each function, and the like in accordance with display control signals received from control section 100. Operation section 22 includes various operation keys such as a numeric keypad and a start key, receives various input operations performed by a user, and outputs operation signals to control section 100.

Image processing section 30 includes a circuit that performs digital image processing suited to initial settings or user settings on the input image data, and the like. For example, image processing section 30 performs tone correction on the basis of tone correction data (tone correction table), under the control of control section 100. In addition to the tone correction, image processing section 30 also performs various correction processes such as color correction and shading correction as well as a compression process, on the input image data. Image forming section 40 is controlled on the basis of the image data that has been subjected to these processes.

Image forming section 40 includes: image forming units 41Y, 41M, 41C, and 41K for images of colored toners respectively containing a Y component, an M component, a C component, and a K component on the basis of the input image data; intermediate transfer unit 42; and the like.

Image forming units 41Y, 41M, 41C, and 41K for the Y component, the M component, the C component, and the K component have a similar configuration. For ease of illustration and description, common elements are denoted by the same reference signs. Only when elements need to be discriminated from one another, Y, M, C, or K is added to their reference signs. In FIG. 1, reference signs are given to only the elements of image forming unit 41Y for the Y component, and reference signs are omitted for the elements of other image forming units 41M, 41C, and 41K.

Image forming unit 41 includes exposure device 411, developing device 412, photoconductor drum 413, charging device 414, drum cleaning device 415 and the like.

Photoconductor drums 413 are, for example, negative-charge-type organic photoconductor (OPC) formed by sequentially laminating an under coat layer (UCL), a charge generation layer (CGL), and a charge transport layer (CTL) on the circumferential surface of a conductive cylindrical body (aluminum-elementary tube) which is made of aluminum and has a diameter of 80 [mm] The charge generation layer is made of an organic semiconductor in which a charge generating material (for example, phthalocyanine pigment) is dispersed in a resin binder (for example, polycarbonate), and generates a pair of positive charge and negative charge through exposure to light by exposure device 411. The charge transport layer is made of a layer in which a hole transport material (electron-donating nitrogen compound) is dispersed in a resin binder (for example, polycarbonate resin), and transports the positive charge generated in the charge generation layer to the surface of the charge transport layer.

Control section 100 controls a driving current supplied to a driving motor (not shown in the drawings) that rotates photoconductor drums 413, whereby photoconductor drums 413 is rotated at a constant circumferential speed.

Charging device 414 evenly negatively charges the surface of photoconductor drum 413. Exposure device 411 is composed of, for example, a semiconductor laser, and configured to irradiate photoconductor drum 413 with laser light corresponding to the image of each color component. Since the positive charge is generated in the charge generation layer of photoconductor drum 413 and is transported to the surface of the charge transport layer, the surface charge (negative charge) of photoconductor drum 413 is neutralized. An electrostatic latent image of each color component is formed on the surface of photoconductor drum 413 by the potential difference from its surroundings.

Developing device 412 is a developing device of a two-component developing type, and attaches toners of respective color components to the surface of photoconductor drums 413, and visualizes the electrostatic latent image to form a toner image.

Drum cleaning device 415 includes a drum cleaning blade that is brought into sliding contact with the surface of photoconductor drum 413, and removes residual toner that remains on the surface of photoconductor drum 413 after the primary transfer.

Intermediate transfer unit 42 includes intermediate transfer belt 421, primary transfer roller 422, a plurality of support rollers 423, secondary transfer roller 424, belt cleaning device 426 and the like.

Intermediate transfer belt 421 is composed of an endless belt, and is stretched around the plurality of support rollers 423 in a loop form. At least one of the plurality of support rollers 423 is composed of a driving roller, and the others are each composed of a driven roller. Preferably, for example, roller 423A disposed on the downstream side in the belt travelling direction relative to primary transfer rollers 422 for K-component is a driving roller. With this configuration, the travelling speed of the belt at a primary transfer section can be easily maintained at a constant speed. When driving roller 423A rotates, intermediate transfer belt 421 travels in an arrow A direction at a constant speed.

Intermediate transfer belt 421 is a belt having conductivity and elasticity which includes on the surface thereof a high resistance layer having a volume resistivity of 8 to 11 [log Ω·cm]. Both positive toner 190 and negative toner 190 remain on intermediate transfer belt 421. Intermediate transfer belt 421 is rotationally driven by a control signal from control section 100. It is to be noted that the material, thickness and hardness of intermediate transfer belt 421 are not limited as long as intermediate transfer belt 421 has conductivity and elasticity.

Primary transfer rollers 422 are disposed to face photoconductor drums 413 of respective color components, on the inner periphery side of intermediate transfer belt 421. Primary transfer rollers 422 are brought into pressure contact with photoconductor drums 413 with intermediate transfer belt 421 therebetween, whereby a primary transfer nip for transferring a toner image from photoconductor drums 413 to intermediate transfer belt 421 is formed.

Secondary transfer roller 424 is disposed to face roller 423B (hereinafter referred to as “backup roller 423B”) disposed on the downstream side in the belt travelling direction relative to driving roller 423A, on the outer peripheral surface side of intermediate transfer belt 421. Secondary transfer roller 424 is brought into pressure contact with backup roller 423B with intermediate transfer belt 421 therebetween, whereby a secondary transfer nip for transferring a toner image from intermediate transfer belt 421 to sheet S is formed.

When intermediate transfer belt 421 passes through the primary transfer nip, the toner images on photoconductor drums 413 are sequentially primary-transferred to intermediate transfer belt 421. To be more specific, a primary transfer bias is applied to primary transfer rollers 422, and electric charge of the polarity opposite to the polarity of the toner is applied to the rear side (the side that makes contact with primary transfer rollers 422) of intermediate transfer belt 421, whereby the toner image is electrostatically transferred to intermediate transfer belt 421.

Thereafter, when sheet S passes through the secondary transfer nip, the toner image on intermediate transfer belt 421 is secondary-transferred to sheet S. To be more specific, a secondary transfer bias is applied to secondary transfer roller 424, and electric charge of the polarity opposite to the polarity of the toner is applied to the rear side (the side that makes contact with secondary transfer roller 424) of sheet S, whereby the toner image is electrostatically transferred to sheet S. Sheet S on which the toner image has been transferred is conveyed toward fixing section 60.

Belt cleaning device 426 (which corresponds to the “cleaning device” of the embodiment of the present invention) includes a belt cleaning blade that is brought into sliding contact with the surface of intermediate transfer belt 421 (which corresponds to the “transfer belt” of the embodiment of the present invention), and removes residual toner that remains on the surface of intermediate transfer belt 421 after the secondary transfer. The specific configurations of belt cleaning device 426 will be described later. Alternatively, it is also possible to adopt a configuration (so-called belt-type secondary transfer unit) in which a secondary transfer belt is installed in a stretched state in a loop form around a plurality of support rollers including a secondary transfer roller.

Fixing section 60 includes upper fixing section 60A having a fixing side member disposed on a fixing surface (the surface on which a toner image is formed) of sheet S, lower fixing section 60B having a back side supporting member disposed on the rear surface (the surface opposite to the fixing surface) side of sheet S, heating source 60C, and the like. Back side supporting member is brought into pressure contact with the fixing side member, whereby a fixing nip for conveying sheet S in a tightly sandwiching manner is formed.

Fixing section 60 applies, at the fixing nip, heat and pressure to sheet S on which a toner image has been secondary-transferred, thereby fixing the toner image on sheet S. Fixing section 60 is disposed as a unit in fixing part F. In addition, fixing part F may be provided with an air-separating unit that blows air to separate sheet S from the fixing side member or the back side supporting member.

Sheet conveyance section 50 includes sheet feeding section 51, ejection section 52, conveyance path section 53 and the like. Three sheet feed tray units 51a to 51c included in sheet feeding section 51 store sheets S (standard sheets, special sheets) discriminated on the basis of the basis weight, the size, and the like, for each type set in advance. Conveyance path section 53 includes a plurality of pairs of conveyance rollers such as a pair of registration rollers 53a.

The recording sheets S stored in sheet tray units 51a to 51c are output one by one from the uppermost, and conveyed to image forming section 40 by conveyance path section 53. At this time, the registration roller section in which the pair of registration rollers 53a are arranged corrects skew of sheet S fed thereto, and the conveyance timing is adjusted. Then, in image forming section 40, the toner image on intermediate transfer belt 421 is secondary-transferred to one side of sheet S at one time, and a fixing process is performed in fixing section 60. Sheet S on which an image has been formed is ejected out of the image forming apparatus by ejection section 52 including sheet discharging rollers 52a.

[Configuration of Main Part of Belt Cleaning Device 426]

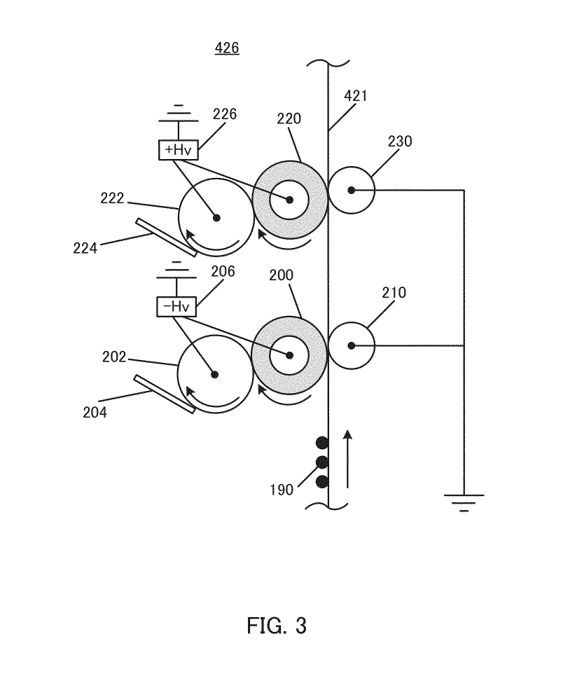

Next, with reference to FIG. 3, the configuration of the main part of belt cleaning device 426 will be described. Belt cleaning device 426 includes first cleaning section 194 and second cleaning section 196. First cleaning section 194 includes first foamed roller 200, first collecting roller 202, first scraper 204, first bias power source 206 (first voltage applying section), and first cleaning opposed roller 210.

First foamed roller 200 includes a mandrel, and an elastic layer that covers the outer periphery of the mandrel. The material of the mandrel is a metal such as aluminum. The material of the elastic layer is a conductive polyurethane foam. First foamed roller 200 is a cleaning roller which is disposed in such a manner that it is rotatable while making contact with intermediate transfer belt 421, and is configured to remove positive (which corresponds to the “first polarity” of the embodiment of the present invention) toner 190 remaining on intermediate transfer belt 421. In order to favorably remove toner 190 on intermediate transfer belt 421, first foamed roller 200 is rotationally driven by a control signal from control section 100 in a counter direction (rotational direction in which the surfaces facing each other move in opposite directions) with respect to intermediate transfer belt 421.

First collecting roller 202 is a cylindrical roller in which the surface of a mandrel made of stainless-steel or the like is covered with an acrylic UV curable resin layer (resistance layer). First collecting roller 202 is a roller which is configured to collect the toner 190 attached on the surface of first foamed roller 200. Therefore, first collecting roller 202 is disposed in such a manner that first collecting roller 202 is rotatable while making contact with the elastic layer (surface) of first foamed roller 200 at part of the outer surface of first collecting roller 202. The surface of first collecting roller 202 may be, for example, plated in order to enhance the smoothness and durability. First collecting roller 202 is rotationally driven by a control signal from control section 100 in a counter direction with respect to first foamed roller 200.

First scraper 204 is a metal plate, or an elastic blade made of elastomer. An end portion of first scraper 204 is pressed against first collecting roller 202, and thus first scraper 204 mechanically scrapes toner 190 attached to the surface of first collecting roller 202.

First cleaning opposed roller 210 is a cylindrical roller made of a metal such as iron, aluminum, and stainless-steel. First cleaning opposed roller 210 is mounted in a freely rotatable manner, and follows the rotation of intermediate transfer belt 421. That is, first cleaning opposed roller 210 is rotationally driven at the same rotation speed as intermediate transfer belt 421. In addition, first cleaning opposed roller 210 is maintained at a ground potential, for example.

First cleaning opposed roller 210 is provided in such a manner that it faces first foamed roller 200 with intermediate transfer belt 421 therebetween. First cleaning opposed roller 210 is pressed by a pressing spring (not illustrated) toward intermediate transfer belt 421 at a predetermined pressure (for example, 6 [N/m]). Further, since first cleaning opposed roller 210 is a relatively hard metal roller, a uniform cleaning nip at which the surface of intermediate transfer belt 421 and first foamed roller 200 make contact with each other is formed. In addition, in order to achieve a favorable cleaning performance while sufficiently ensuring the width of the cleaning nip, first cleaning opposed roller 210 is disposed in such a manner as to be shifted to the downstream side in the travelling direction of intermediate transfer belt 421 (upward in the drawing, the same shall apply hereinafter), by a predetermined distance (for example, 2 [mm]) from first foamed roller 200. First cleaning opposed roller 210 is grounded, and thus the electric charge accumulated to intermediate transfer belt 421 can be released to the ground.

First bias power source 206 is connected to first foamed roller 200 and first collecting roller 202, and applies a predetermined voltage to first foamed roller 200 and first collecting roller 202. The voltage application operation of first bias power source 206 is controlled by control section 100. It is to be noted that the power supply mode of first bias power source 206 may be either the constant current control or the constant voltage control. It should be noted that, to securely ensure a potential difference, the constant voltage control is preferable.

In response to a control signal from control section 100, first bias power source 206 applies a negative bias voltage to first foamed roller 200. In addition, first cleaning opposed roller 210 is grounded. Thus, between intermediate transfer belt 421 and first foamed roller 200, an electrostatic force in the direction from intermediate transfer belt 421 to first foamed roller 200 acts on positive toner 190 remaining on intermediate transfer belt 421. As a result, positive toner 190 remaining on intermediate transfer belt 421 attaches to first foamed roller 200. Thereafter, toner 190 attached to first foamed roller 200 is oppositely charged from positive to negative, by a bias voltage applied to first foamed roller 200.

In response to a control signal from control section 100, first bias power source 206 applies a negative bias voltage to first collecting roller 202. That is, first foamed roller 200 and first collecting roller 202 are set to have a potential of the same polarity.

In the present embodiment, the bias voltage applied to first foamed roller 200 (for example, −2000 [V]) is lower than the bias voltage applied to first collecting roller 202 (for example, −1500 [V]). That is, the absolute value of the potential of first foamed roller 200 is set to a value higher than the absolute value of the potential of first collecting roller 202. Thus, between first foamed roller 200 and first collecting roller 202, an electrostatic force in the direction from first foamed roller 200 to first collecting roller 202 acts on negatively and oppositely charged toner 190. That is, toner 190 which is attached to first foamed roller 200 and is oppositely charged efficiently moves to first collecting roller 202, and therefore does not again attaches to intermediate transfer belt 421. Toner 190 moved to first collecting roller 202 is scraped from the surface of first collecting roller 202 by first scraper 204.

Second cleaning section 196 is disposed on the downstream side of first cleaning section 194 in the travelling direction of intermediate transfer belt 421. Second cleaning section 196 includes second foamed roller 220, second collecting roller 222, second scraper 224, second bias power source 226 (second voltage applying section), and second cleaning opposed roller 230. That is, second cleaning section 196 has substantially the same configuration as first cleaning section 194. While first cleaning section 194 removes positive toner 190, second cleaning section 196 removes negative toner 190.

Second bias power source 226 is connected to second foamed roller 220 and second collecting roller 222, and applies a predetermined voltage to second foamed roller 220 and second collecting roller 222. The voltage application operation of second bias power source 226 is controlled by control section 100. It is to be noted that the power supply mode of second bias power source 226 may be either the constant current control or the constant voltage control. It should be noted that, to securely ensure a potential difference, the constant voltage control is preferable.

In response to a control signal from control section 100, second bias power source 226 applies a positive bias voltage to second foamed roller 220. In addition, first cleaning opposed roller 210 is grounded. Thus, between intermediate transfer belt 421 and second foamed roller 220, an electrostatic force in the direction from intermediate transfer belt 421 to second foamed roller 220 acts on negative toner 190 remaining on intermediate transfer belt 421. As a result, negative toner 190 remaining on intermediate transfer belt 421 attaches to second foamed roller 220. Thereafter, toner 190 attached to second foamed roller 220 is oppositely charged from negative to positive, by a bias voltage applied to second foamed roller 220.

In response to a control signal from control section 100, second bias power source 226 applies a positive bias voltage to second collecting roller 222. That is, second foamed roller 220 and second collecting roller 222 are set to have a potential of the same polarity.

In the present embodiment, the bias voltage applied to second foamed roller 220 (for example, +2000 [V]) is higher than the bias voltage applied to second collecting roller 222 (for example, +1500 [V]). That is, the absolute value of the potential of second foamed roller 220 is set to a value higher than the absolute value of the potential of second collecting roller 222. Thus, between second foamed roller 220 and second collecting roller 222, an electrostatic force in the direction from second foamed roller 220 to second collecting roller 222 acts on positively and oppositely charged toner 190. That is, toner 190 which is attached to second foamed roller 220 and is oppositely charged efficiently moves to second collecting roller 222, and therefore does not again attaches to intermediate transfer belt 421. Toner 190 moved to second collecting roller 222 is scraped from the surface of second collecting roller 222 by second scraper 224.

### Effect of the Present Embodiment

As has been described in detail, in the present embodiment, belt cleaning device 426 includes first cleaning section 194 and second cleaning section 196, first cleaning section 194 including: first foamed roller 200 disposed in such a manner that it is rotatable while making contact with intermediate transfer belt 421, and configured to remove a positive toner remaining on intermediate transfer belt 421; first collecting roller 202 disposed in such a manner that it is rotatable while making contact with first foamed roller 200, and configured to collect a toner attached to first foamed roller 200; and first bias power source 206 configured to apply, to first foamed roller 200, a voltage for electrostatically attaching a positive toner existing on intermediate transfer belt 421 to first foamed roller 200 and for oppositely charging the toner, and to apply, to first collecting roller 202, a voltage for electrostatically attaching the toner oppositely charged at first foamed roller 200 to first collecting roller 202 from first foamed roller 200, second cleaning section 196 including: second foamed roller 220 disposed in such a manner that it is rotatable while making contact with intermediate transfer belt 421, and configured to remove a negative toner remaining on intermediate transfer belt 421, on the downstream side of first foamed roller 200 in a travelling direction of intermediate transfer belt 421; second collecting roller 222 disposed in such a manner that it is rotatable while making contact with second foamed roller 220, and configured to collect a toner attached to second foamed roller 220; and second bias power source 226 configured to apply, to second foamed roller 220, a voltage for electrostatically attaching a positive toner existing on intermediate transfer belt 421 to second foamed roller 220 and for oppositely charging the toner, and to apply, to second collecting roller 222, a voltage for electrostatically attaching the toner oppositely charged at second foamed roller 220 to second collecting roller 222 from second foamed roller 220.

According to the above-mentioned configuration of the present embodiment, since belt cleaning device 426 includes first cleaning section 194 and second cleaning section 196, positive toner and negative toner can be efficiently removed even when both the positive toner and negative toner remain on the intermediate transfer belt. To be more specific, an electrostatic force in the direction from first foamed roller 200 to first collecting roller 202 acts on (negative) toner 190 which is oppositely charged after being removed by first foamed roller 200. Thus, (positive) toner 190 which is once removed from first foamed roller 200 and is oppositely charged efficiently moves to first collecting roller 202 before again attaching to the surface of intermediate transfer belt 421 from first foamed roller 200 side. In addition, an electrostatic force in the direction from second foamed roller 220 to second collecting roller 222 acts on (positive) toner 190 which is oppositely charged after being removed by second foamed roller 220. Thus, (negative) toner 190 which is once removed from second foamed roller 220 and is oppositely charged efficiently moves to second collecting roller 222 before again attaching to the surface of intermediate transfer belt 421 from second foamed roller 220 side.

Thus, favorable cleaning for intermediate transfer belt 421 can be achieved.

[Modification]

While intermediate transfer belt 421 corresponds to the “transfer belt” of the embodiment of present invention in the above-mentioned embodiment, the present invention is not limited to this. For example, when image forming apparatus 1 includes a secondary transfer belt configured to transfer toner 190 on intermediate transfer belt 421 to a sheet, the secondary transfer belt may correspond to the “transfer belt” of the embodiment of the present invention. In this case, toner 190 which has not been transferred to a sheet by the transfer operation and remains on the secondary transfer belt can be appropriately removed by applying the present invention.

In addition, while second cleaning section 196 is disposed on the downstream side of first cleaning section 194 in the travelling direction of intermediate transfer belt 421 in the above-mentioned embodiment, second cleaning section 196 may be disposed on the upstream side of first cleaning section 194 in the travelling direction of intermediate transfer belt 421.

In addition, while, in the above-mentioned embodiment, the bias voltage applied to second foamed roller 220 (for example, +2000 [V]) is higher than the bias voltage applied to second collecting roller 222 (for example, +1500 [V]) so that an electrostatic force in the direction from second foamed roller 220 to second collecting roller 222 acts on positively and oppositely charged toner 190, the present invention is not limited to this. For example, it is also possible to apply a bias voltage (for example, +2000 [V]) only to second foamed roller 220 with second collecting roller 222 grounded so that an electrostatic force in the direction from second foamed roller 220 to second collecting roller 222 acts on positively and oppositely charged toner 190. This configuration makes it unnecessary to control the applying operation for second collecting roller 222.

In addition, while, in the above-mentioned embodiment, the bias voltage applied to first foamed roller 200 (for example, −2000 [V]) is lower than the bias voltage applied to first collecting roller 202 (for example, −1500 [V]) so that an electrostatic force in the direction from first foamed roller 200 to first collecting roller 202 acts on negatively and oppositely charged toner 190, the present invention is not limited to this. For example, it is also possible to apply a bias voltage (for example, −2000 [V]) only to first foamed roller 200 with first collecting roller 202 grounded so that an electrostatic force in the direction from first foamed roller 200 to first collecting roller 202 acts on negatively and oppositely charged toner 190. This configuration makes it unnecessary to control the applying operation for first collecting roller 202.

In addition, in the above-mentioned embodiment, first foamed roller 200 and first collecting roller 202 may be set to have opposite potentials. For example, the potentials of first foamed roller 200 and first collecting roller 202 may be set to −2000 [V] and +2500 [V], respectively. In addition, second foamed roller 220 and second collecting roller 222 may be set to have opposite potentials. For example, the potentials of second foamed roller 220 and second collecting roller 222 may be set to +2000 [V] and −2500 [V], respectively.

In addition, while cleaning sections 194 and 196 are separate two components in the above-mentioned embodiment, they may be provided as one component, or three or more components. When the number of the cleaning section is one, a charger (PCC) that makes the polarity of the toner remaining on intermediate transfer belt 421 uniform is provided on the upstream side of the cleaning section in the travelling direction of intermediate transfer belt 421. Now, a case in which the number of the cleaning section is three will be described.

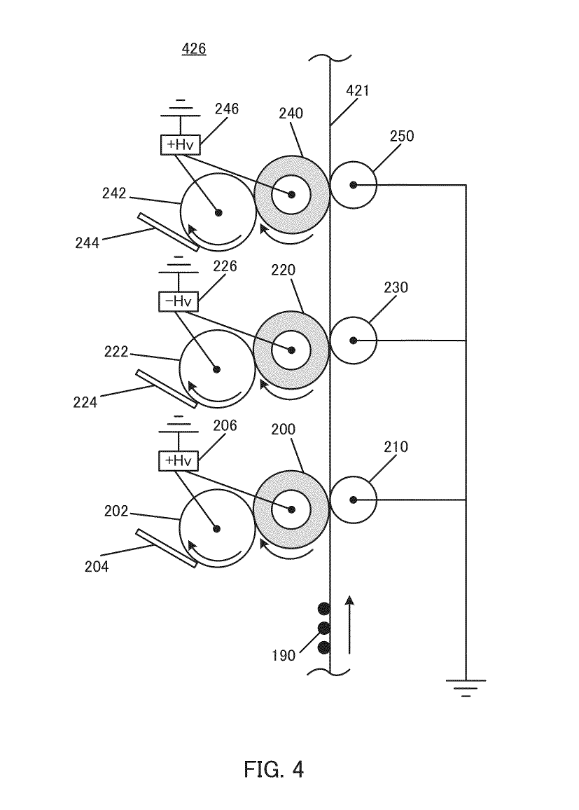

As illustrated in FIG. 4, belt cleaning device 426 includes third cleaning section 198, in addition to the configuration illustrated in FIG. 3. Third cleaning section 198 is disposed on the downstream side of second cleaning section 196 in the travelling direction of intermediate transfer belt 421. Third cleaning section 198 includes third foamed roller 240, third collecting roller 242, third scraper 244, third bias power source 246 (third voltage applying section), and third cleaning opposed roller 250. That is, third cleaning section 198 has substantially the same configuration as first cleaning section 194. It is to be noted that third cleaning section 198 may be disposed on the upstream side of second cleaning section 196 in the travelling direction of intermediate transfer belt 421.

With the configuration illustrated in FIG. 4, a small amount of (positively charged) toner 190 which has not been removed by first and second cleaning sections 194 and 196 can be electrically and mechanically removed. Thus, in comparison with the configuration illustrated in FIG. 3, the cleaning for intermediate transfer belt 421 can be achieved more favorably.

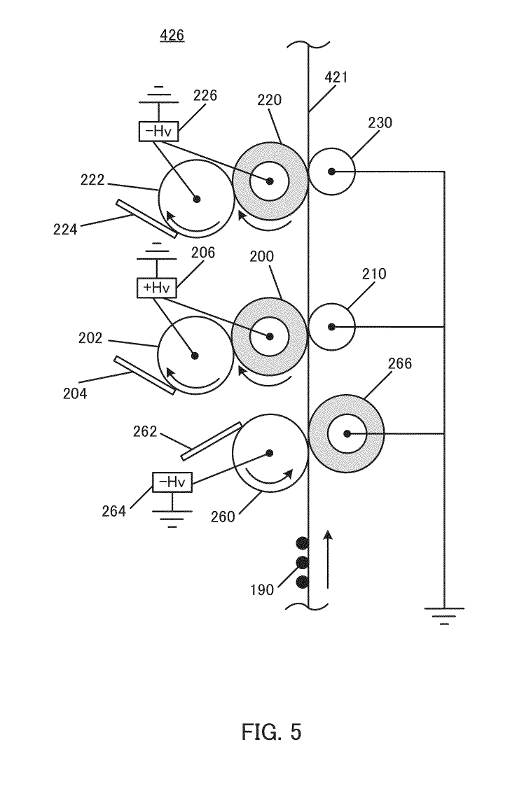

In addition, in the above-mentioned embodiment, belt cleaning device 426 may include hard roller 260 at a position on the upstream side of first cleaning section 194 in the travelling direction of intermediate transfer belt 421. A configuration of the main part of belt cleaning device 426 in this case will be described with reference to FIG. 5. Here, differences from belt cleaning device 426 illustrated in FIG. 3 will be described.

As illustrated in FIG. 5, belt cleaning device 426 includes, in addition to the configuration illustrated in FIG. 3, hard roller 260, scraper 262, bias power source 264, and cleaning opposed roller 266. Bias power source 264 is connected to hard roller 260. It is to be noted that, in the configuration illustrated in FIG. 5, the polarities of the bias voltages applied to first and second foamed rollers 200 and 220, and first and second collecting rollers 202 and 222 are opposite to the polarities of the configuration illustrated in FIG. 3.

Hard roller 260 is conductive, and has a hardness enough to resist abrasion due to the contact with scraper 262. To be more specific, hard roller 260 includes a phenol resin (resistance layer) whose hardness is about 100 to 120 (Rockwell hardness M scale). Hard roller 260 is formed by pressing a metal mandrel into a resin pipe formed by extrusion molding. Hard roller 260 includes on the surface thereof a high resistance layer having a volume resistivity of 7 to 9 [log Ω·cm].

Hard roller 260 is disposed in such a manner that it is rotatable while making contact with the surface of intermediate transfer belt 421, and is configured to remove toner 190 remaining on intermediate transfer belt 421. In order to prevent an excessive load from being exerted on hard roller 260, hard roller 260 rotates in a with direction (rotational direction in which the surfaces facing each other move in the same direction) with respect to intermediate transfer belt 421. Hard roller 260 is rotationally driven by a control signal from control section 100.

In response to a control signal from control section 100, bias power source 264 applies a negative voltage to hard roller 260. In addition, cleaning opposed roller 266 is grounded. Thus, between intermediate transfer belt 421 and hard roller 260, an electrostatic force in the direction from intermediate transfer belt 421 to hard roller 260 acts on positive toner 190 remaining on intermediate transfer belt 421. Toner 190 attached to hard roller 260 is scraped from the surface of hard roller 260 by scraper 262.

With the configuration illustrated in FIG. 5, positive toner 190 remaining on intermediate transfer belt 421 can be pre-cleaned by using hard roller 260, in comparison with the configuration illustrated in FIG. 3. Accordingly, the amount of the positively charged toner which is supposed to be removed by second cleaning section 196 can be reduced. In addition, of toner 190 remaining on intermediate transfer belt 421, toner 190 which is positively or negatively charged at around 0 is more strongly negatively charged, and thus negatively charged toner 190 can be efficiently removed by first cleaning section 194.

Further, in belt cleaning device 426 in the above-mentioned embodiment, hard roller 260 may be disposed on the downstream side of second cleaning section 196 in the travelling direction of intermediate transfer belt 421.

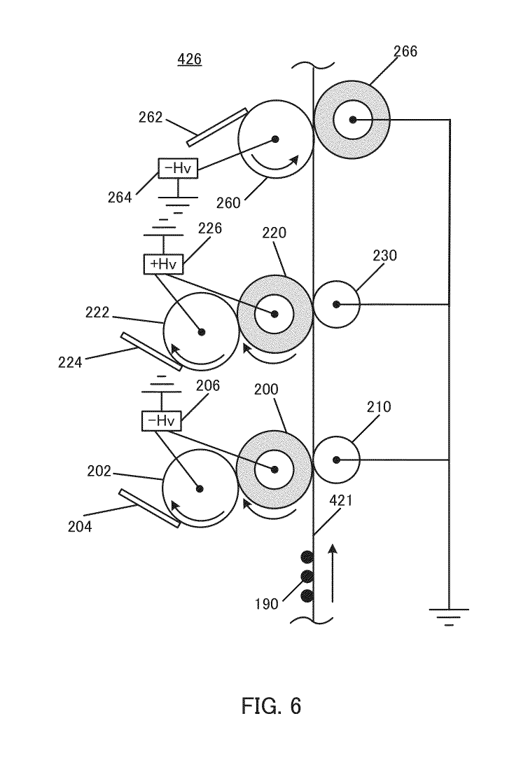

With the configuration illustrated in FIG. 6, a small amount of toner 190 (positively charged) which has not been removed by first cleaning section 194 can be electrically and mechanically removed by using hard roller 260 in comparison with the configuration illustrated in FIG. 3. Thus, in comparison with the configuration illustrated in FIG. 3, a favorable cleaning for intermediate transfer belt 421 can be achieved.

The embodiments disclosed herein are merely exemplifications and should not be considered as limitative. The scope of the present invention is specified by the following claims, not by the above-mentioned description. It should be understood that various modifications, combinations, sub-combinations and alterations may occur depending on design requirements and other factors in so far as they are within the scope of the appended claims or the equivalents thereof.

What is claimed is:

1. A cleaning device comprising a first cleaning section and a second cleaning section,
the first cleaning section including:
a first foamed roller disposed in such a manner that the first foamed roller is rotatable while making contact with a transfer belt, the first foamed roller being configured to remove toner of a first polarity remaining on the transfer belt;
a first collecting roller disposed in such a manner that the first collecting roller is rotatable while making contact with the first foamed roller, the first collecting roller being configured to collect toner attached to the first foamed roller; and
a first voltage applying section configured to apply, to the first foamed roller, a voltage for electrostatically attaching the toner of the first polarity existing on the transfer belt to the first foamed roller and for oppositely charging the toner, and to apply, to the first collecting roller, a voltage for electrostatically attaching the toner oppositely charged at the first foamed roller to the first collecting roller from the first foamed roller;
the second cleaning section including:
a second foamed roller disposed on a downstream side of the first foamed roller in a travelling direction of the transfer belt in such a manner that the second foamed roller is rotatable while making contact with the transfer belt, the second foamed roller being configured to remove toner of a second polarity remaining on the transfer belt, the second polarity being opposite to the first polarity;
a second collecting roller disposed in such a manner that the second collecting roller is rotatable while making contact with the second foamed roller, the second collecting roller being configured to collect toner attached to the second foamed roller; and
a second voltage applying section configured to apply, to the second foamed roller, a voltage for electrostatically attaching the toner of the second polarity existing on the transfer belt to the second foamed roller and for oppositely charging the toner, and to apply, to the second collecting roller, a voltage for electrostatically attaching the toner oppositely charged at the second foamed roller to the second collecting roller from the second foamed roller.

2. The cleaning device according to claim 1, wherein
the first voltage applying section applies, to the first collecting roller, a voltage which has a same polarity as a polarity of a voltage applied to the first foamed roller and is lower in absolute value than the voltage applied to the first foamed roller, and
the second voltage applying section applies, to the second collecting roller, a voltage which has a same polarity as a polarity of a voltage applied to the second foamed roller and is lower in absolute value than the voltage applied to the second foamed roller.

3. The cleaning device according to claim 1, wherein
the first voltage applying section applies, to the first collecting roller, a voltage which has a polarity opposite to a polarity of a voltage applied to the first foamed roller, and
the second voltage applying section applies, to the second collecting roller, a voltage which has a polarity opposite to a polarity of a voltage applied to the second foamed roller.

4. The cleaning device according to claim 1 further comprising a third cleaning section,
the third cleaning section including:
a third foamed roller disposed on an upstream side of the first foamed roller or on a downstream side of the second foamed roller in the travelling direction of the transfer belt in such a manner that the third foamed roller is rotatable while making contact with the transfer belt, the third foamed roller being configured to remove toner remaining on the transfer belt;
a third collecting roller disposed in such a manner that the third collecting roller is rotatable while making contact with the third foamed roller, the third collecting roller being configured to collect toner attached to the third foamed roller; and
a third voltage applying section configured to apply, to the third foamed roller, a voltage for electrostatically attaching the toner existing on the transfer belt to the third foamed roller and for oppositely charging the toner, and to apply, to the third collecting roller, a voltage for electrostatically attaching the toner oppositely charged at the third foamed roller to the third collecting roller from the third foamed roller.

5. The cleaning device according to claim 1 further comprising a hard roller disposed on an upstream side of the first the cleaning section in the travelling direction of the transfer belt in such a manner that the hard roller is rotatable while making contact with the transfer belt, the hard roller being configured to remove toner remaining on the transfer belt.

6. The cleaning device according to claim 1 further comprising a hard roller disposed on a downstream side of the second cleaning section in the travelling direction of the transfer belt in such a manner that the hard roller is rotatable while making contact with the transfer belt, the hard roller being configured to remove toner remaining on the transfer belt.

7. An image forming apparatus comprising a first cleaning section and a second cleaning section,
the first cleaning section including:
a first foamed roller disposed in such a manner that the first foamed roller is rotatable while making contact with a transfer belt, the first foamed roller being configured to remove toner of a first polarity remaining on the transfer belt;
a first collecting roller disposed in such a manner that the first collecting roller is rotatable while making contact with the first foamed roller, the first collecting roller being configured to collect toner attached to the first foamed roller; and
a first voltage applying section configured to apply, to the first foamed roller, a voltage for electrostatically attaching the toner of the first polarity existing on the transfer belt to the first foamed roller and for oppositely charging the toner, and to apply, to the first collecting roller, a voltage for electrostatically attaching the toner oppositely charged at the first foamed roller to the first collecting roller from the first foamed roller;
the second cleaning section including:
a second foamed roller disposed on a downstream side of the first foamed roller in a travelling direction of the transfer belt in such a manner that the second foamed roller is rotatable while making contact with the transfer belt, the second foamed roller being configured to remove toner of a second polarity remaining on the transfer belt, the second polarity being opposite to the first polarity;
a second collecting roller disposed in such a manner that the second collecting roller is rotatable while making contact with the second foamed roller, the second collecting roller being configured to collect toner attached to the second foamed roller; and
a second voltage applying section configured to apply, to the second foamed roller, a voltage for electrostatically attaching the toner of the second polarity existing on the transfer belt to the second foamed roller and for oppositely charging the toner, and to apply, to the second collecting roller, a voltage for electrostatically attaching the toner oppositely charged at the second foamed roller to the second collecting roller from the second foamed roller.

8. The image forming apparatus according to claim 7, wherein
the first voltage applying section applies, to the first collecting roller, a voltage which has a same polarity as a polarity of a voltage applied to the first foamed roller and is lower in absolute value than the voltage applied to the first foamed roller, and
the second voltage applying section applies, to the second collecting roller, a voltage which has a same polarity as a polarity of a voltage applied to the second foamed roller and is lower in absolute value than the voltage applied to the second foamed roller.

9. The image forming apparatus according to claim 7, wherein
the first voltage applying section applies, to the first collecting roller, a voltage which has a polarity opposite to a polarity of a voltage applied to the first foamed roller, and
the second voltage applying section applies, to the second collecting roller, a voltage which has a polarity opposite to a polarity of a voltage applied to the second foamed roller.

10. The image forming apparatus according to claim 7 further comprising a third cleaning section,
the third cleaning section including:
a third foamed roller disposed on an upstream side of the first foamed roller or on a downstream side of the second foamed roller in the travelling direction of the transfer belt in such a manner that the third foamed roller is rotatable while making contact with the transfer belt, the third foamed roller being configured to remove toner remaining on the transfer belt;
a third collecting roller disposed in such a manner that the third collecting roller is rotatable while making contact with the third foamed roller, the third collecting roller being configured to collect toner attached to the third foamed roller; and
a third voltage applying section configured to apply, to the third foamed roller, a voltage for electrostatically attaching the toner existing on the transfer belt to the third foamed roller and for oppositely charging the toner, and to apply, to the third collecting roller, a voltage for electrostatically attaching the toner oppositely charged at the third foamed roller to the third collecting roller from the third foamed roller.

11. The image forming apparatus according to claim 7 further comprising a hard roller disposed on an upstream side of the first the cleaning section in the travelling direction of the transfer belt in such a manner that the hard roller is rotatable while making contact with the transfer belt, the hard roller being configured to remove toner remaining on the transfer belt.

12. The image forming apparatus according to claim 7 further comprising a hard roller disposed on a downstream side of the second cleaning section in the travelling direction of the transfer belt in such a manner that the hard roller is rotatable while making contact with the transfer belt, the hard roller being configured to remove toner remaining on the transfer belt.
